(19) United States
(12) Patent Application Publication
(10) Pub. No.: US 2009/0241821 A1
(43) Pub. Date: Oct. 1, 2009

(54) Pallet storage installation for stock keeping of goods to be stored, in particular for the use in ships

(76) Inventors: Jorg Schauland, Winsen (Luhe) (DE); Frank Bottger, Lubeck (DE)

Correspondence Address: Friedrich Kueffner, Suite 910, 317 Madison Avenue, New York, NY, 10017, US

(21) Appl. No.: 12/215,381

(22) Filed: Jun. 26, 2008

(30) Foreign Application Priority Data
Mar. 31, 2008 (DE) 20 2008 004 425.1
May 29, 2008 (DE) 20 2008 007 269.7

(51) Int. Cl. B65G 1/04; B65D 19/02; B63B 25/22

(52) U.S. Cl. 114/72; 108/55.1; 108/56.1; 414/572; 700/215; 414/266

(57) ABSTRACT

A pallet storage installation for stock keeping of goods to be stored for use in a ship includes storage rows placed on both sides of a storage aisle, a transport device movable in the storage aisle for storing in and out pallets with a carrier plate into the storage rows, wherein storage rows for forming several store rooms separated by walls which can be separated by walls are placed on both sides of the storage aisle, wherein each pallet is configured as a box with a carrier plate and with side walls, whereby the carrier plate is provided with stands placed in the carrier plate corner areas.

### BACKGROUND OF THE INVENTION

1. Field of the Invention

The present invention relates to a pallet storage installation for stock keeping of goods to be stored, in particular for use in a ship, comprising storage rows placed on both sides of a storage aisle, a transport device movable in the storage aisle for storing in and out pallets with a carrier plate into the storage rows, wherein storage rows which can form several store rooms separated by walls are placed on both sides of the storage aisle.

2. Description of the Related Art

A pallet storage installation of this type is known from EP 1 406 051. For the stock keeping of different goods in ships, there are partition walls in order to form different storage rooms. The partition walls are made of stainless steel or of aluminium coated panels and are fixed in the storage room. Usual commercial pallets are used in the separated storage rooms.

A device for ships for shifting a load carried by a first transport pallet onto an empty second pallet is shown and described in DE 21 31 086 A. High quality pallets made of hygienic material are used for the in-plant transport. On the other hand, wooden pallets are used outside the ship. The load is then reloaded by the device onto the stainless steel pallets. However, the load can displace or fall down during the reloading.

### SUMMARY OF THE INVENTION

The aim of this invention is to configure a pallet storage installation of the type described in the introduction in such a manner that the pallets made of a hygienic material are secured inside the pallet storage installation against lateral tilting and that the security measures against fire and intrusion of water foreseen for a ship are not impaired when displacing the pallets between two ship storage rooms separated from each other by bulkheads. Furthermore, the possibility should be created according to which the goods to be stored such as food and luxury food on pallets deposited in the storage rooms of the ship can be stored in an environment specifically air conditioned for the goods to be stored.

This aim is achieved by a pallet storage installation in which each pallet is configured as a box with a carrier plate and with side walls, wherein the carrier plate is provided with stands placed in the carrier plate corner areas.

Accordingly, the invention consists in that each pallet is configured as a box with a carrier plate and with side walls, whereby the carrier plate is provided with stands placed in the carrier plate corner areas.

The side walls fixed on the in-ship pallets avoid that the loads on the pallets can slip out and fall down. The stands placed on the carrier plates of the pallets avoid a tilting of the pallets with the whole load when displacing the pallets by means of a preferably rail mounted transport device inside the pallet storage installation or from a storage room to another. If the side walls of the pallet or the side walls of the grid box are configured as a grid and are thus permeable to air, it is possible with an appropriate air conditioning of the storage rooms to achieve a keeping quality of the goods to be stored over a longer period.

While for the solution according to the EP 1 406 051 the load is supported on the fixed walls on the storage room and for this solution the pallets thus must have a fixed ordered position in order to avoid a falling down of the load, it is possible according to the invention, de to the side walls acting as supporting walls, to place the pallet at any location since the load or the provision can be supported on the walls of the pallet and be secured in this way.

Pallets placed the one behind the other or besides the other form together a side wall so that these walls can replace the fixed side walls of the storage room or constitute the partition walls of the storage room, whereby the placement of grid walls on the carrier plates of the pallets makes possible an air conditioning of the storage rooms in which the pallets or the grid boxes are stored with their loads so that the goods to be stored can be stored at the temperatures which are respectively necessary.

Advantageous configurations of the invention are characterized in the subclaims.

In an advantageous configuration of the invention, the side walls of the pallets are designed as grid walls. Thus there is created a grid box. This has the advantage that on the one hand the load is safely fixed since the grid construction is optimal for this because cardboard boxes can be easily supported on the grid, on the other hand the load can easily be seen in order to easily identify the cardboard boxes with provision or the like, The construction which is thus created results in a grid box which, moreover, has a low weight. The grid walls are situated on the basic construction. 2, 3 or 4 grid walls can exist. The walls are fixedly connected with the basic construction. But detachable or collapsible walls are also conceivable.

Accordingly, the invention provides that for configuring the grid box the side walls of the pallet are designed with massive walls or as grid walls which are placed fixedly or removable on the carrier plate.

The number of grid walls placed on the carrier plate can be any. As an alternative, it is also possible that the grid box has two or three side walls. Due to the lacking side wall(s), the load can also be loaded in and out. Another solution consists in that one or several side walls are connected detachably with the carrier plate. The removable side wall(s) also create a loading and unloading side. If a side wall or several side walls are configured as a door, the load can be loaded in and out, whereby the closed grid box optionally secures the load.

The grid box configured open on the upper side can be closed by means of a covering part which is configured with massive walls or as a grid wall and which is removably connected with the side walls or the grid walls so that the loading and unloading of the grid box can also take place from the top. Advantageously the side walls and/or grid walls are fixedly or removably connected with each other so that, when the side walls are removed, the stacking of the goods to be stored is also possible directly on the carrier plate.

A further embodiment provides that cross struts or rack shelves or full surface or grid-shaped rack plates are placed between the side walls or the grid walls in order to constitute shelves with one compartment or several compartments. The special advantage which is achieved herewith consists in that the rigidity of the construction is increased by the cross struts placed between the side walls. The struts of the walls are preferably placed horizontally, whereby there are in particular shelves as cross struts so that rack plates or cases can be hanged like in a shelf. The grid box can also be designed similarly to a wardrobe a chest of drawers.

A further advantageous configuration of the invention consists in that the transport device consists of a transfer carriage travelling manually or motor-driven or of a longitudinal transfer carriage travelling in the storage aisle of the pallet storage installation and a transverse transfer carriage travelling in the storage rows and that each carrier plate is provided respectively with four stands which are placed for securing the pallets or the grid boxes against lateral tilting in such a manner that they laterally overlap the runner rails of the transport device, whereby a transport carriage is placed between the runner rails which preferably have a L-shaped profile.

A further advantageous improvement of the invention consists in that the carrier plates are provided with four stands instead of skids. The space under the basic construction and between the stands can be used for the automatic transport. The space height can be better used by this. An automatic transport vehicle moves the grid box, whereby it lifts the grid boy and drives into an alley which is limited by a runner rail or the like. This being, the studs hang outside the runner rail. The runner rail serves as running rail for the transport vehicle and simultaneously as guiding and load retention for the transport unit. The runner rails are a guiding device for the transport carriage or the floor conveyor and serve simultaneously as safety device for the load carrier or for the grid box. The runner rail can be configured as L-profile, U-profile or as hat profile which assumes the combination of a runner rail and a load safety device. The runner rail can be dressed for the mounting which can ideally also still be used for adjusting works. The runner rail simultaneously holds the pallet when the transport vehicle has unloaded the pallet. The grid box can bear with the carrier plate and/or the stands on the runner rail. Moreover, the runner rail can be provided with stopping elements or positioning elements which are situated on the runner rail or on one side. These elements are then situated between the pallets so that the lowered grid boxes cannot slip away. The positioning elements can be formed wedge-shaped or conical in such a manner that the grid box can glide into an ideal position. Due to the partitioning into storing, dealing and manipulating areas, different rules can be used for these areas. This type of stock keeping meets the usual hygiene prescriptions. The length of the stands is dimensioned such that one the one hand the pallets can be seized by fork lift trucks or other lifting devices and that on the other hand the runner rails can be encompassed laterally so that runner rails and the grid boxes form stable units.

The conveying device for the pallets of the pallet storage installation can also be designed for example as a roller or chain conveyor. The runner rails for the transport carriages are mounted on the floor and are placed in particular so that they can be walked on or driven on with floor conveyors. This is guaranteed mainly by a sufficient distance between the runner rails. Preferably, the installation is designed such that a pallet movement is possible even without the automatic conveying technique. Furthermore, the design is such that the transport carriage and the rest of the conveying technique can also be operated without a central control. This is advantageous for being able to further operate the storage space in case of a breakdown of the control. The installation can also be designed such that the storage space can be operated manually with or without floor conveyors.

It is very advantageous when a pallet changer exists in the pallet storage installation which reloads the load which is situated on external pallets onto external pallets. This being, in particular each carrier plate is made of a hygienic carrier material such as stainless steel or an appropriate synthetic material, whereby the pallet storage installation is preferably equipped with a pallet changer in order to reload incoming load on wooden pallets into the carrier plates provided with the hygienic carrier material. Provision is namely essentially delivered in wooden pallets. With a pallet change of the known type, the load can be reloaded from the wooden pallets onto the stainless steel pallets. This operation can take place automatically or partially automatically.

This operation can also be integrated into an automatized storeroom in a ship or be carried out independently from this. Preferably, the reloading should take place by pushing the load onto a stainless steel base.

In a further preferred embodiment of the installation, it is provided that bulkheads and/or closable doors exist between parts of the installation. The bulkheads with or without doors or door walls can divide the storage room of the ship into single store rooms in which the pallet storage installation is placed. The runner rails for the transport carriages run then from one storeroom to other storerooms and to distribution stations or to kitchen areas or to elevators when the kitchen rooms are situated in other decks of the ship. The doors can be travelling or closable sliding doors or double wing doors. Safety prescriptions with respect to fire and intrusion of water can thus be observed. The protection against intrusion of water takes place with bulkheads which are provided with closable doors. These safety devices are designed in particular so that the closing of the doors is not impaired in case of emergency by jammed transport carriages. A conveying device and the transport carriages are designed such that in case of emergency or incident the goods to be transported or the transport carriage can be safely removed from the door opening so that the doors can be duly closed. In case of emergency, objects which are squeezed between the doors are recognized and for example electrically or manually removed. This being, it is appropriate to have a sensor device existing in the bulkhead or door area for detecting the transport carriage or other objects situated in the door area.

The electric removal of the pallet can take place by a sliding mechanism or the like. The safety device is designed such that even in case of power failure squeezed objects can be removed.

The conveying device for the pallets and the transport carriages are so designed that they can pass through the safety doors. This is not only the case for water resisting and fireproof doors but in particular also for insulated cooling room doors. Appropriately a control for an automatic storage is provided too. This is structured in such a manner that in case of emergency or of an incident it creates a safe state as quickly as possible and closes all the necessary doors etc. This state can only be terminated by authorized staff. The control is preferably conceived in such a manner that in case of too big ship movements the transport carriage is brought into a safe position and is locked. This state too can be suppressed again only by authorized staff.

A further preferred embodiment of the invention consists in that there exists an automatized system for preparing a pallet packing list with a pallet detection system for detecting the pallets and an information processing system for preparing the pallet packing list.

The provision or the spare parts, hotel requirements and all the further goods which are delivered onto a ship and in particular onto a cruise ship are namely generally provided with a pallet packing list. This list is used for the checking of the packed goods.

An electronic list which however does not refer to the single pallet but to the whole delivery is also possible. Generally the whole load is repacked or unpacked without an automatic system so that a “pallet packing list” is not relevant. On the contrary, for the automatic system of the installation according to the invention for which the pallet is completely reloaded, this invention is very important. Thus, the information about the pallet packing list is electronically delivered to the ship system and processed.

It is advantageous that the pallets are provided with an information carrier means and the information carrier means is a RFID tag, a bar code or a chip.

It is thus possible that the list is delivered with the pallet and is sent with the RFID or a similar technique directly on arrival on the ship to the pallet changer or to the input station. Furthermore, it is possible that the information is sent beforehand and that only the assignment of the pallet number and of the pallet list is made. This can take place electronically by a bar code, a chip or another technique.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is a perspective view of an embodiment of a pallet with two grid-shaped side walls and a covering part as an upper cover;

FIG. 2 is a schematic representation of an area of a pallet storage installation;

FIG. 3 is a perspective representation of an embodiment of a pallet configured as a grid box;

FIG. 4 is a front view representation of a transport unit consisting of a transport carriage with a grid box set thereon;

FIG. 5 shows a further embodiment of a pallet with the transverse braces which connect both side walls or with shelves;

FIG. 6 shows a schematic representation of a reloading operation of a load from a wooden pallet to a stainless steel pallet or to a grid box;

FIG. 7 is a representation of a system for preparing a pallet list;

FIG. 8 is a perspective view of a pallet storage installation;

FIG. 9 is a top view of a part of a pallet storage installation;

FIG. 10 is a front view of the pallet storage installation of FIG. 2, as seen from the direction III-III.

### DETAILED DESCRIPTION OF THE INVENTION

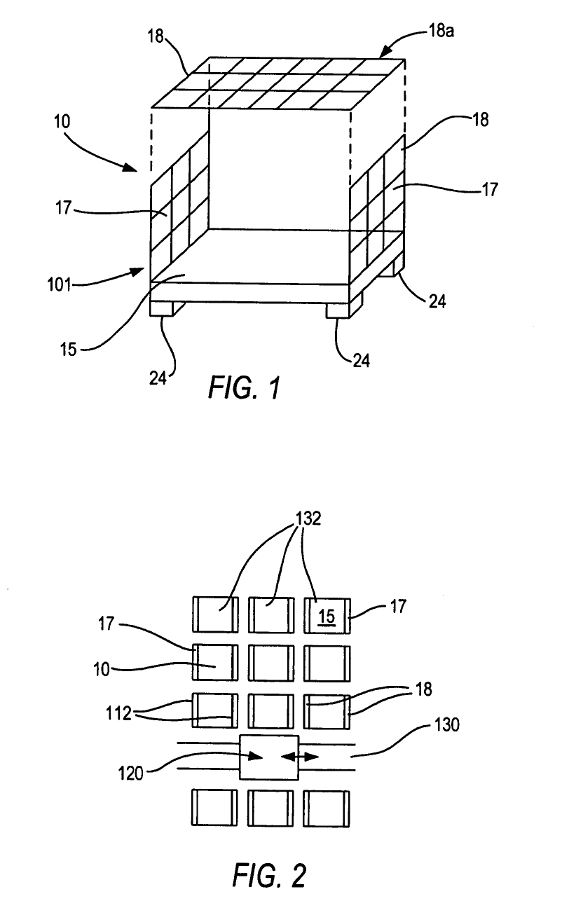

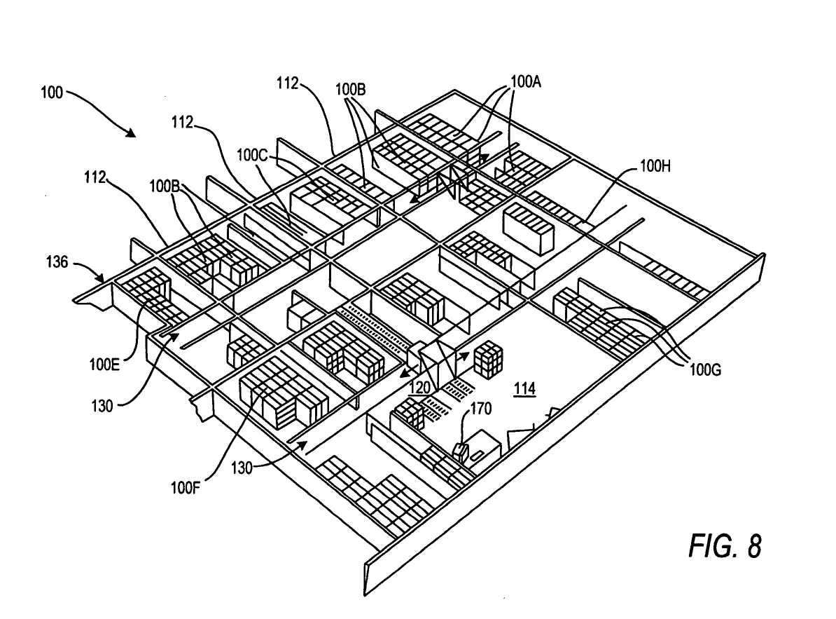

FIG. 1 shows a pallet 1 of a pallet storage installation 100 which is partially shown in FIG. 2. The installation 100 serves for stock keeping of goods to be stored for the use in a ship. On both sides of a storage aisle 130, storage rows 132 are placed, as illustrated in FIG. 2. Moreover, a transport device 120 travelling in the storage aisle 130 exists which is provided with a longitudinal transport carriage 122 travelling in the storage aisle 130 and with a transverse transport carriage 124 travelling in the storage row 132, whereby the arrangement of the installation can take place in adaptation to the respective requirements in longitudinal or transverse direction to the ship geometry. A differently configured transport carriage 26 as a transport device 120 is shown in FIG. 4. This carriage serves for the storing in and out of pallet units with a carrier plate 15 into the storage rows 132 (FIGS. 8, 9 and 10).

On both sides of the storage aisle 130 there are several store rooms separated by fixed walls 112. These walls 112 form substantially the bulkheads which separate the store rooms of the ship from each other with closable doors as safety measures against fire and intrusion of water.

The single pallets 101 consist of the carrier plates 15 on which side walls 17 are fixed. These side walls 17 form, for pallets placed in a row 101 partition walls of a storage row 132 so that additional fixed walls or partition walls are not necessary in the ship. In this simple manner, the load is secured when the pallets 101 are placed in the storage rows 132. But during the transport into the storage rows 132 too, the load is secured so as not to fall out since the pallets 101 secure the load without additional safety means. In FIG. 2, the single pallets 101 are shown spaced from each other, however only in order to be able to better distinguish them from each other. Otherwise, the pallets 101 are placed the one behind the other in a row in the ship they are placed relatively close to each other so that the single side walls 17 can be supported the one against the other for example in case of rough sea.

For separating the store rooms of the ship into single store rooms by means of the pallets 101 having side walls 17, the side walls 17 are configured massive, whereby each carrier plate can have two, three or four side walls 17.

As FIG. 1 shows, the side walls 17 of the pallet 101 are designed as grid walls. In this example, two opposed grid walls 18 exist which, as FIG. 2 shows, are driven into the storage aisle 132 in such a manner that they are placed along the storage aisles 132. The grid walls 18 are fixedly or removably connected with the carrier plate 15. The load can be loaded in or out on both open sides. Alternatively three grid walls 18 are provided on the carrier plate 15. The carrier plate 15 with the grid walls 18 is completed to the grid box 10. Instead of grid walls 18, the carrier plate 15 can also be provided with side walls 17 which are provided with openings which are configured as slits or which also have another geometrical shape. However, it is essential that the side walls 17 are configured permeable to air as the grid walls 18 in order to be able to feed cold air in air conditioned store rooms to the goods not only in one grid box but in order to air condition the whole store room with the temperature which is respectively necessary.

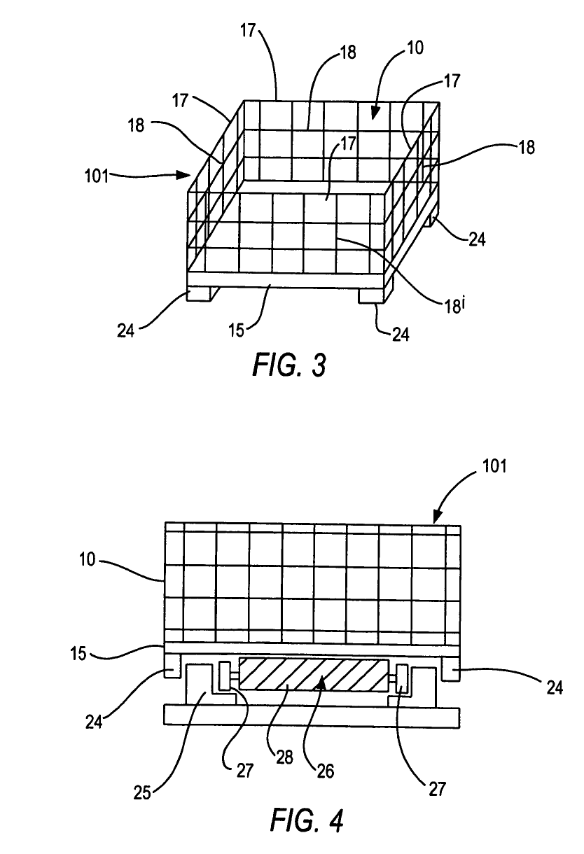

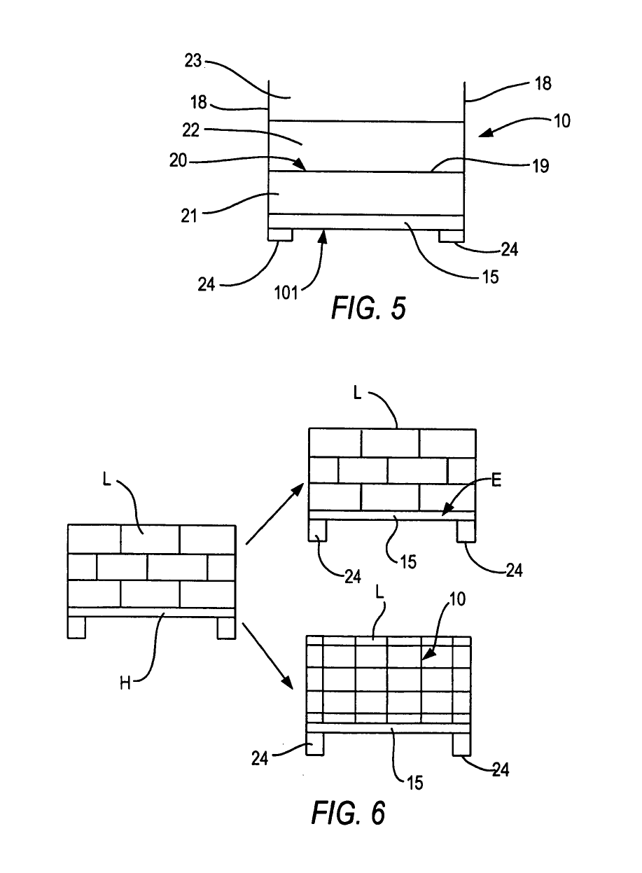

As FIG. 3 shows, four grid walls 18 can be provided, three of which are fixedly connected with the carrier plate 15 while the fourth grid wall 18′ or also the carrier plate 15 is configured either as a door or detachable so that the load is accessible. Several doors or detachable grid walls 18 can also exist, whereby the doors can be placed in the side walls 17 or the grid walls 18.

Moreover, each carrier plate 15 is provided with four stands 24 on the lower side or on the corners of the carrier plate 15 (FIG. 3). Runner rails 25 are placed between the stands 24, rails on which one transport carriage 26 which constitutes the transport device 120 is placed so as to be movable. The stands 24 avoid a lateral tilting out of the pallet 10. The transport carriage 26 is provided with rollers 27 which rest on the runner rails 25. The carrier plate 15 rests on a flat carrier body 28 so that the carrier plate 15 is spaced from the runner rails 25. The stands 24 cooperate with the runner rails 25 and serve as guides for the pallet 10. The rollers 27 are also guided on and by the runner rails 25. This is achieved by a L-shape of the runner rails 25. But U-shaped or hat-shaped runner rail profiles are also conceivable. It is essential that the stands 24 laterally overlap the runner rails 25.

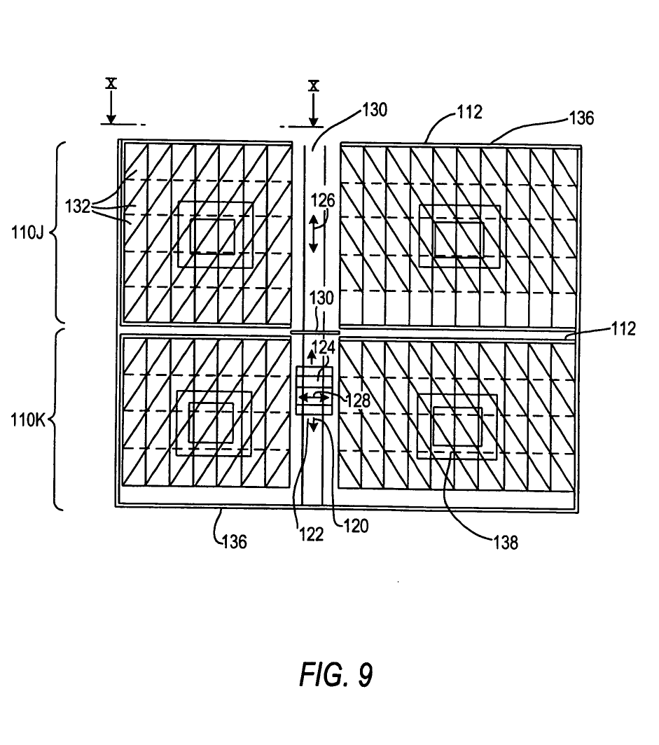

The transport carriage 26 according to FIG. 2 is movable along the storage aisle 130 and can reach the single rows 12. A further embodiment consists in that the transport device 120 does not consist only of a transport carriage 26 according to FIG. 4 but of a longitudinal transport carriage 122 and a transverse transport carriage 124 functionally cooperating with this carriage (FIG. 9).

Preferably, the pallet storage installation 100 comprises a pallet changer which is not shown in detail for reloading incoming load which is situated on external pallets onto internal pallets 101 of the pallet storage installation 100. The reloading principle is shown in FIG. 6. Since food delivered on wooden pallets does not comply with the hygienic requirements, it is appropriate to reload it onto stainless steel pallets. Thus, it is provided that each carrier plate 15 is made of a hygienic carrier material such as stainless steel or an appropriate synthetic material. The pallet change does not serve to reload the load on stainless steel pallets but also the load on pallets with grid walls 18 or grid boxes 10.

FIG. 6 shows an incoming wooden pallet H. The load L can then be reloaded onto a stainless steel pallet E or onto a grid box G by a pallet changer configured in a manner known in itself.

Bulkheads which are not shown in detail and/or closable doors between parts of the installation also exist in order to offer a protection in case of fire or intrusion of water. In order to avoid that these doors are not blocked by pallets, there is also a sensor device for detection of the transport carriage 26, of a pallet 101 or of other objects situated in the door area. The sensor can be a camera, a light barrier or the like.

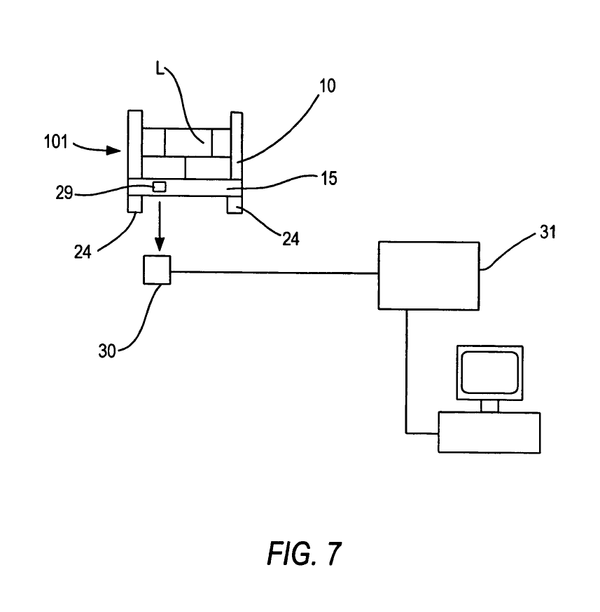

An automatic system for preparing a pallet packing list is also provided for. FIG. 7 shows a pallet detection system for the detection of the pallet 10 with an information processing system for preparing the pallet packing list. The pallet 10 is provided with a RFID tag 29 which stored an information about the load L which exists on the pallet 10. The information is read with a reading device 30 when passing along a reading area and is transmitted to an information processing system which prepares the pallet packing list. Instead of the RFID tag, another information carrier means such as for example a bar code can also be used.

The pallet storage installation 100 contains a multitude of store rooms which are separated from each other by the grid walls of the grid box 10 or of several grid boxes. The store rooms can additionally serve for stock keeping of different goods to be stored. This being, additional partition walls can also be placed. The store rooms can have air conditioning devices which adjust a predetermined temperature and/or a predetermined atmosphere. Rooms with temperatures of −20 to −25° C. for frozen goods, +4° to +10° C. for food and/or drinks can be air conditioned. Rooms with another atmosphere such as with controlled inert gas for inflammable or corrodible goods to be stored are also possible.

A commissioning area with several commissioning places is advantageous. This can be reached with the transport device. The transport device 120 has several access areas for bringing or removing goods to be stored.

The pallet storage installation 100 can be divided into several store rooms which are separated from each other by additional partition walls, whereby in this very case the partition walls can be formed by the pallets 101 or by the grid boxes 10. The side walls of the pallets 101 can form further storage aisles or store rooms so that further partition walls of the store rooms are thus created.

Besides cooling rooms with different cooling areas, dry freight rooms and storage freight rooms are also conceivable. Air conditioning devices can have N2 or CO2 generators.

Besides provision, the pallet storage installation can also receive ammunition. Double-walled walls or intermediate walls filled with water which can absorb the detonation energy are used for this purpose. The grid boxes 10 of the pallets 101 can then also be configured according to safety prescriptions.

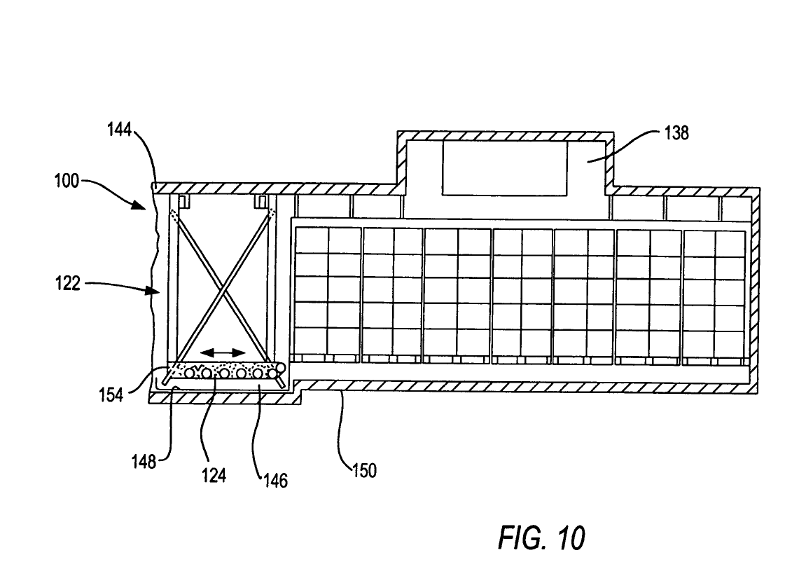

A perspective overall view of a pallet storage installation 100 mounted in a ship is represented in FIG. 8. The pallet storage installation 100 contains a multitude of store rooms 100A to 100H which are separated from each other by partition walls 112 which are provided with closable doors and which constitute the bulkheads 136. The store rooms 100A to 100H serve for the storage of different goods to be stored. At least, a few of the store rooms 100A to 100H have thus air conditioning devices (FIGS. 9 and 10) below the room ceiling which is not represented in FIG. 8 which adjust a predetermined temperature and/or a predetermined atmosphere in the respective store room.

For example, the store rooms 110A and 100B can serve at a temperature of −25° C. for storing fish or meat, the room 100C at a temperature of −20° C. for storing of poultry and vegetables, the room 100D at a temperature of +4° C. for storing of milk products and the rooms 100G and 100H at a temperature of +10° C. for storing drinks such as mineral water, lemonades, beer and high-percentage alcoholic drinks. In the room 100E, in the embodiment, a storing area for inflammable and corrodible goods to be stored is created due to a controlled inert gas atmosphere without oxygen, the room 100F is provided as dry freight room.

Moreover, the pallet storage installation 100 has a commissioning area 114 with several commissioning places. This commissioning area can be reached with a transport device which is described in detail below which can be driven into different access areas 116 for supplying or removing goods to be stored.

The cut-out of FIG. 9 shows a view of the basic structure of the pallet storage installation 100. Two store rooms 100J and 100K which are separated from each other by a partition wall 112 or a bulkhead 136 are represented. Each store room 100J, 100K has several storage rows 132 which receive respectively one pallet 101 in their width. The partition walls for configuring several store rooms are formed by the pallets 101 configured as grid boxes 10.

In one storage aisle 130 which traverses the store rooms, a movable transport device 100 is arranged which has, as a transport device 120, a longitudinal transport carriage 122 and a transverse transport carriage 24 placed thereon. The longitudinal transport carriage 122 is movable, as shown by the arrows 126, along the storage aisle 130 and the transverse transport carriage 124 is movable from the longitudinal transport carriage 122 in direction of the arrows 128 into the single storage rows 132.

As it will be explained further below, a bulkhead 136 is provided for the atmospheric separation of the differently air conditioned store rooms 100J and 100K in the area of the storage aisle 30.

The mode of function of the transport device 120 is explained in more detail with reference to the FIG. 10. FIG. 10 shows a front view of the pallet storage installation of FIG. 9, seen from the direction X-X. The longitudinal transport carriage 122 is guided in the runner rail 25. A transport platform 146 of the longitudinal transport carriage 122 is preferably situated in a recess 148 of the room floor 150 so that the semi-mounted transverse transport carriage 124 can be moved from the transport platform 145 by means of runner rails on rollers 154 into the single storage rows 132. The longitudinal transport carriage 122 does not have necessarily to be placed movable in a recess; it can also be situated in a recess or a lowering with oblique sides. The recess offers the advantage for the required height for the arrangement of the installation. It is also possible to suppress the recess which is advantageous for the manual use of the conveyor vehicles for the emergency service.

The transverse transport carriage 124 is always connected to the longitudinal transport carriage 122 by supply lines which can be wound up and which are not represented such as current cables, control cables and the like for the driving in and out into the storage rows 132. The operation of the transverse transport carriages can also take place with accumulators. The width of each storage row 132 corresponds to the width to the width of the transverse transport carriage. Moreover, it is selected so big as to be able to go into the storage rows 132 and to drive into them with floor conveyors in order to safeguard a safety access in case the automatic supply with the transport device 120 would fail.

If goods to be stored, for example provision, is required from a store room, the corresponding pallet with the provision load is brought by the transport device 120 into the commissioning area 114 and it moved there with the transverse transport carriage 124 into one of the access areas. In the access area, the required provision quantity is removed manually from the load on the transport device and is guided to further processing. The transverse transport carriage 124 is then weighed with the rest load and the known weight of the transverse transport carriage 124 is deduced from the total weight. The weight of the rest load obtained as a result is stored by a control and monitoring unit 170 (FIG. 8). The respective provision quantity can thus be controlled in order for example to order new provision if the provision quantity of a certain foodstuff tends to be too low. The accesses to the goods to be stored are appropriately detected and memorized by the control and monitoring unit 170 too.

In the embodiment, each good to be stored can be deposited at any location by taking into account the climatic requirements since the control and monitoring unit 170 memorizes the storage space or each good to be stored. For example, mineral water, lemonades and beer can be stacked the one above the other or the one behind the other in a pallet in a storage row. If then lemonade has to be picked up, the other part of the load is deposited in a free space and the lemonade load is brought into the commissioning area where the wished quantity is removed. The rest load of lemonade is then brought together with the other load parts again to the storage space.

The control and monitoring unit 170 also checks partially used load units and stores together as far as possible the goods which can be put together because of their structure. This can be made automatically or the control and monitoring unit 170 can suggest to the operator which partially used load units can be put together.

The control and monitoring unit 170 further detects the expiration dates of perishable goods such as milk or sausage. When the expiration date is close or exceeded, a warning information is given to the store keeper.

In the embodiment, the frequency of access to certain goods to be stored is also detected and memorized by the control and monitoring unit. The most frequently used goods are stored as close as possible to the aisle and to the commissioning area 114 so that a quick access to these goods is secured to achieve the shortest possible transport times without reloading. On the contrary, seldom used goods are stored in remote storage rows.

The control and monitoring unit 170 also assumes the monitoring of the temperature and, if need be, of the gas composition of the air conditioned store rooms, for example of the oxygen or carbon dioxide content. For this purpose, appropriate measuring devices which are connected with the control and monitoring unit 170 are provided in the store rooms.

Besides cooling rooms with different cooling areas to refrigerating rooms, dry freight rooms and store rooms with inert gas atmosphere are also provided. The stability of fruit and vegetables can be substantially increased by using inert gas. The air conditioning devices have N2 or CO2 generators, eventually an O2 supply is also provided for supplying the store rooms.

The storage rows 132 can be closed by doors to the storage aisle 130. A lock is configured by lateral sliding doors in the area of the storage aisle. The transport device 120 drives into this lock and the sliding doors are closed so that cooled air from the storage row arrives only into the lock but not into the whole storage aisle 130 and into storage rows with other climatic conditions.

In the embodiment, the control and monitoring unit 170 is formed by a computer with appropriate software and peripheral devices for the control of the external devices.

While specific embodiments of the invention have been shown and described in detail to illustrate the inventive principles, it will be understood that the invention may be embodied otherwise without departing from such principle.

We claim:

1. A pallet storage installation for stock keeping of goods to be stored, in particular for use in a ship, comprising storage rows placed on both sides of a storage aisle, a transport device movable in the storage aisle for storing in and out pallets with a carrier plate into the storage rows, wherein storage rows which can form several store rooms separated by walls are placed on both sides of the storage aisle, wherein each pallet is configured as a box with a carrier plate and with side walls, wherein the carrier plate is provided with stands placed in the carrier plate corner areas.

2. The pallet storage installation according to claim 1, wherein the side walls of the pallet are configured massive or, for configuring a grid box, are provided with openings or are designed as grid walls which are placed fixedly or removably or collapsible on the carrier plate.

3. The pallet storage installation according to claim 1, wherein a grid wall or two, three or four grid walls are placed on the carrier plate.

4. The pallet storage installation according to claim 1, wherein two grid walls which are opposite are placed on the carrier plate.

5. The pallet storage installation according to claim 1, wherein the grid box configured open on the upper side can be closed by means of a covering part which is configured with massive walls or as a grid wall and which is removably connected with the side walls or the grid walls.

6. The pallet storage installation according to claim 1, wherein the side walls and/or the grid walls are fixedly or removably connected with each other.

7. The pallet storage installation according to claim 1, wherein one or several side walls or grid walls are configured as doors or have doors.

8. The pallet storage installation according to claim 1, wherein cross struts or rack plates or full surface or grid-shaped rack plates are placed between the side walls or the grid walls in order to constitute shelves with one compartment or several compartments.

9. The pallet storage installation according to claim 8, wherein the shelves are detachably fixed with the side walls, are preferably configured hangable.

10. The pallet storage installation according to claim 1, comprising a pallet changer for reloading incoming load which is situated on external pallets onto internal pallets of the pallet storage installation.

11. The pallet storage installation according to claim 1, wherein each carrier plate is made with its side walls or grid walls of a hygienic carrier material such as stainless steel or an appropriate synthetic material, whereby the pallet storage installation is preferably equipped with a pallet changer in order to reload incoming load on wooden pallets (H) into the carrier plates made of the hygienic carrier material.

12. The pallet storage installation according to claim 1, comprising bulkheads and/or closable doors between parts of the installation or of partition walls.

13. The pallet storage installation according to claim 12, comprising a sensor device existing in the bulkhead area for detecting transport carriages or other objects situated in the door area.

14. The pallet storage installation according to claim 1, comprising an automatic system for preparing a pallet packing list with a pallet detection system for detecting the pallets and an information processing system for preparing the pallet packing list.

15. The pallet storage installation according to claim 14, wherein the pallets are provided with an information carrier means.

16. The pallet storage installation according to claim 15, wherein the information carrier means is a RFID tag, a bar code or a chip.

17. The pallet storage installation according to claim 1, wherein the transport device consists of a transfer carriage travelling manually or by means of an engine or of a longitudinal transfer carriage travelling in the storage aisle of the pallet storage installation and a transverse transfer carriage travelling in the storage rows and that each carrier plate is provided respectively with four stands which are placed for securing the pallets or the grid boxes against lateral tilting in such a manner that they laterally overlap runner rails of the transport device, whereby a transport carriage is placed between the runner rails which preferably have a L-shaped profile.

18. The pallet storage installation according to claim 1, wherein
a) on both sides of the storage aisle storage rows are placed which form several store rooms in which different climatic conditions are adjustable, whereby the air conditioned store rooms have respectively a measuring device cooperating with the control and monitoring unit which detects the temperature and/or the gas composition of the atmosphere,
b) that at least one part of the separated store rooms has respectively an air conditioning device which adjusts a predetermined temperature and/or a predetermined atmosphere, in particular with predetermined oxygen, carbon dioxide or inert gas content in the store room and
c) that the control and monitoring unit monitors the quantity of goods to be stored which are supplied to or removed from the commissioning area and controls the storing-in of goods into a store room with the climatic conditions adapted to the respective goods to be stored.

19. The pallet storage installation according to claim 18, wherein the air conditioned store rooms are protected against each other by atmospheric locks in the storage aisle.

20. The pallet storage installation according to claim 18, wherein the longitudinal transport carriage is guided in runner rails fixed at a room ceiling of the store room.

21. The pallet storage installation according to claim 18, wherein the transverse transport carriage is semi-mounted onto the longitudinal transport carriage and is movable by means of runner rails placed along the storage rows into the single storage rows.

22. The pallet storage installation according to claim 18, wherein the store rooms are divided by means of partition walls and are made of stainless steel or of aluminium coated panels.

23. The pallet storage installation according to claim 18, wherein the partition walls separate the store rooms from each other waterproof, fireproof and gas proof.

24. The pallet storage installation according to claim 18, wherein at least one store room is provided with double walled partition walls which can be filled with water, preferably additionally with a double walled ceiling facing which can be filled with water.

25. The pallet storage installation according to claim 18, wherein the control and monitoring unit detects the frequency of access to the goods and that stores in the goods to be stored with a transport distance to the commissioning area which corresponds to their frequency of access.

26. The pallet storage installation according to claim 18, wherein the control and monitoring unit detects expiration dates of goods to be stored and produces a warning indication for these goods before or when reaching the expiration date.

27. The pallet storage installation according to claim 18, wherein the control and monitoring unit monitors the stored quantity of goods to be stored and produces a warning indication for these goods when exceeding a predetermined minimal quantity.
